(19) United States
(12) Patent Application Publication
(10) Pub. No.: US 2004/0215405 A1
(43) Pub. Date: Oct. 28, 2004

(54) Mold transfer pressure measurement and inline control

(76) Inventors: Rosil P. Siloy, La Trinidad (PH); Victor E. E. Generosa, Baguio City (PH); Anthony S. D. Panagan, Baguio City (PH)

Correspondence Address: TEXAS INSTRUMENTS INCORPORATED, P O BOX 655474, M/S 3999, DALLAS, TX, 75265

(21) Appl. No.: 10/420,275

(22) Filed: Apr. 22, 2003

(51) Int. Cl. G01L 7/00

(52) U.S. Cl. 702/50

(57) ABSTRACT

A method for accurate measurement of transfer pressure and inline control of the process during molding of semiconductor devices. The method includes providing at least two pressure measurements devices 51, 57 on the main hydraulic line 52 of a multiplunger mold press, and software in the controller unit 54 programming to compare the measurement values with preset tolerance limits. By controlling the pressure and providing a second measurement to assure measurement accuracy, yield and reliability failures related to warped or distorted packages or package components due to inaccurate pressure control are avoided, as well as failures due to wire sweep.

### FIELD OF THE INVENTION

The present invention relates generally to encapsulation of semiconductor devices by transfer molding, and more specifically to a process for controlling molding pressure.

### BACKGROUND OF THE INVENTION

The semiconductor industry continuously strives for smaller circuit sizes, package sizes, and device footprints. The assembled circuits also require shorter interconnections for faster and higher levels of performance. One solution for shrinking the device footprint and decreasing the interconnection length has been realized by placing metal contacts, typically solder balls, directly under the package body, thereby eliminating external leads which protrude from the package sides, as is the case with leaded packages. The general terminology for metal contact balls under the package is BGA (ball grid array).

The industry not only demands smaller size and higher performance devices, but also continuously strives for lower package cost, which in turn drives a preference for highly automated processes. Well learned assembly processes such as wire bonding to interconnect the chip and interposer, and transfer molding to encapsulate the bonded chip and interposer assemblage are known to facilitate lower costs.

An approach to meeting the need for very small assembled circuits has involved development of a new class of packages, called “chip scale” packages wherein the total area is less than 1.5 times the chip area. Typically smaller packages are assembled on an insulating flexible film interposer having patterned metal interconnections on the surface facing the chip with vias which connect to metal balls, typically solder, on the opposite surface. The solder balls provide electrical and mechanical contact with the next level of interconnection.

One example of a near chip scale package compatible with highly automated manufacturing processes is the Texas Instruments Incorporated Microstar™ device, as illustrated in FIG. 1. The device includes a chip 11 having wire bonds 12 connected to an insulating flex film substrate 10 with patterned metal interconnections 13 on the first surface 101 of the substrate. A patterned lead 13 terminates in a copper foil land 15 which is positioned atop a via 14. The chip 11, bond wires 12, and first surface 101 of the interposer are overmolded by a thermosetting resin 17, prior to attaching solder balls 16 on the second surface 102 through vias 14 to the copper lands 15. The solder balls 16 provide external contacts to a circuit board or other next level of interconnection (not shown).

In recent years the preferred process for molding very thin packages, as well as other devices which are sensitive to wire sweep, makes use of multiplunger molding equipment to fill each mold cavity where a chip and substrate assemblage has been positioned. The multiplunger mold equipment has decided advantages for high quality molding, as compared to conventional single plunger high density molds. The improvements result from more uniform process controls and in completely filling each cavity. Specific mold process parameters, such as temperature, transfer pressure and time, clamping force, and cure time may be programmed into the system controller unit.

As shown schematically in FIG. 2, hydraulic pressure during injection of the molding compound and filling the cavities of a multiplunger mold equipment 25 is measured by an analog gauge 21 positioned on the main hydraulic line 22 leading from the pressure source 27 to plungers in the mold equipment 25. The gauge may be read manually, and the gauge reading is converted to digital data by a hydraulic converter board 23 which converts the gauge 21 output to digital format, and transmits the data to a monitor 24 on the system controller. The converter board 23 not only makes conversions, but also is used for calibration in the event of discrepancies between the analogue and digital data. However, it should be recognized that because the gauge is read manually, many semiconductor devices may be processed before the discrepancy is noted and corrective action taken.

Technology for molding materials, equipment and processes has advanced significantly over the years, but it should be recognized that issues of package distortion, and particularly distortion of thinner and more ductile components of the device is an ongoing problem. The semi-molten thermosetting resin is forced into a mold cavity under pressure which may result in defects such as warpage of the fully molded device, distortion of a component of the package, bond wire sweep, or out of plane external leads or contacts. These defects are the source of many yield and reliability failures, including but not limited to opens between the device and circuit board, and to intermittent and high resistance contacts. These failures are a result of cracks in the solder joints, delamination between conductors, or insufficient contact to make good solder connection. Unfortunately, many of the problems are not detected and corrective action is not taken until a large number of devices have been fabricated, and in some cases until the devices have been assembled by the end user.

It would be advantageous to the industry if a molding process complete with necessary pressure controlling apparatus to permit production of high quality packages were available, and if a means for inline detection and control of molding pressure were established.

### SUMMARY OF THE INVENTION

A first embodiment of the invention provides a molding process for production of distortion free semiconductor packages by providing inline pressure control during the molding transfer operation. The process provides for an improved multiplunger mold equipment having two or more pressure measurement devices installed on the main hydraulic line which are read independently during the mold filling operation by the mold system controller. Substrates having attached semiconductor chips are positioned in cavities of the molding equipment, and the equipment is activated to inject a thermosetting resin under pressure into the mold cavities. Pressure data from the two measurement devices is compared by the software in the mold controller unit. A deviation in transfer pressure outside the set tolerance limits is flagged to stop input of additional devices to be molded, thereby providing an inline control of the process to prevent ongoing production of defective devices. If no deviation is detected, the molding process continues.

Accurate inline pressure measurements and control of the molding process is not limited to, but is particularly applicable to flex film BGA type devices having ductile components, to thin molded packages, and to those devices sensitive to wire sweep.

According to a second embodiment, molding equipment including one or more independent pressure monitoring device on the hydraulic line between the pressure source and the mold plungers is provided. The molding equipment may be provided by modifications to an existing multiplunger mold press. In addition to a first pressure measurement device which may include remote digital output data, a second measurement device, preferably a digital pressure transducer for extracting data from the same hydraulic line is included to monitor the hydraulic pressure, and to provide an independent measurement. According to the mold press configuration, additional pressure measurement devices could be added if needed. Software in the mold controller unit compares pressure data from the measurements, and if a deviation greater than the preset tolerance limit is detected, input to the mold equipment is halted.

The molding process including independent pressure measurements provides inline control of the process and avoids production of distorted semiconductor packages or components of the packaged devices caused by lack of pressure control.

For a more complete understanding of the present invention, and the advantages thereof, reference is made to the following description taken in connection with the accompanying drawings.

### BRIEF DESCRIPTION OF THE DRAWINGS

FIG. 1 is a chip scale packaged device of prior art.

FIG. 2 schematically shows the location of a pressure gauge of a prior art multiplunger mold.

FIG. 3a demonstrates a prior art warped ball landing pad as a result of excessive molding pressure.

FIG. 3b is a cross-sectional view of a prior art distorted copper landing pad with attached solder ball.

FIG. 4 is a cross-sectional view of a prior art mold cavity with substrate and attached chip.

FIG. 5 illustrates an embodiment pressure gauge arrangement with independent measurement data fed to a system controller and monitor.

### DETAILED DESCRIPTION OF THE DRAWINGS

A process providing accurate inline measurement and control of transfer pressure during molding of semiconductor packages is facilitated by two or more independent pressure measurements on the hydraulic line supplying transfer pressure to the mold plungers, comparing the data from the measurements, comparing the data to preset tolerance limits, and if deviations between the measurements exceed a specified value, the molding process is halted. Providing more than one inline pressure measurement reduces the probability of ongoing production of distorted packages or packages having distorted components as a result of inaccurate molding transfer pressure, and further, provides inline process control of the molding process.

In order to more readily comprehend the significance of the invention, an example of failure to control molding pressure is provided in FIGS. 3a and 3b. The drawings schematically represent a portion of a flex film chip scale package, as illustrated in FIG. 1. FIG. 3a shows a detailed cross section of a copper ball landing pad 35 with pressure on the pad 35, represented by arrows 351, causing bowing of the pad from the plane of the interposer 30. Distortion of the pad 35 is a result of excessive pressure during injection of mold compound to encapsulate the chip and substrate. A conductive metal trace 34 on the flex film interposer terminates in the landing pad 35 which is positioned atop an open via through the film 30, and to which the solder ball will be attached subsequent to overmolding. FIG. 3b shows the solder ball 36 attached to the deformed landing pad 35. As a result of the distortion, the height of the solder ball 36 may be out of plane with other solder balls on the same package, and thus may result in a poor solder connection to a circuit board. Further, because of the distortion, the ball landing pad may become delaminated from the film and separated from the interconnecting metal trace 34, thereby causing an open circuit.

Because copper is a ductile material, and the pad atop an open via is unsupported, this type of failure can result from a small amount of excess pressure. Sensitivity for this problem is increased by an increase in the copper pad area, and/or a decrease in copper thickness. Therefore, precise pressure control during molding of such devices is required.

In FIG. 4, a chip 41 on a BGA type substrate 40 is positioned in a cavity 49 of a multiplunger mold press having an upper 48 and lower mold plate 47. The chip 41 with wire bonds 42 is assembled onto the substrate 40 with vias 43, and faces the mold cavity 49. The backside of the substrate is protected from ingress of mold compound by a supporting mold plate 47. The plates 47 and 48 are clamped, and at relatively high temperature the semi-molten molding compound, typically a thermoset epoxy, is forced under pressure through a runner 44 and into the cavity 49 to encapsulate the device. By precise control of the molding pressure, bond wire sweep by the mold compound will be reduced, and the substrate or ductile pads 45 over vias 43 may not become distorted.

A molding process having accurate inline pressure control is applicable not only to CSP or BGA devices, but also to very thin leaded packages, such as TSOP (thin small outline packages). Very thin leaded packages are most frequently fabricated on copper alloy lead frames, and the ductility of these substrates provides little support against warpage of the molded package body caused by poorly controlled molding pressure. Excessive molding pressure, coupled with elevated process temperatures, and thermal mismatches of the device components, chip, lead frame and mold compound, have been found to cause distorted thin packages. Leaded packages which are warped are difficult to test accurately by automated test equipment, and are difficult to assemble and interconnect to printed circuit boards.

Production of devices having long and/or thin bond wires which are subject to wire sweep is benefited by accurate pressure control. Thickness of gold bond wires has decreased over time as the number of input/output terminals has increased, and therefore the probability of wires being swept together or into close proximity to each other by the flow of mold compound has increased.

A process for accurate control of hydraulic pressure during molding is facilitated by two or more independent measurements of the pressure, and comparison of the data to insure that discrepancies between the measurements do not exceed defined limits.

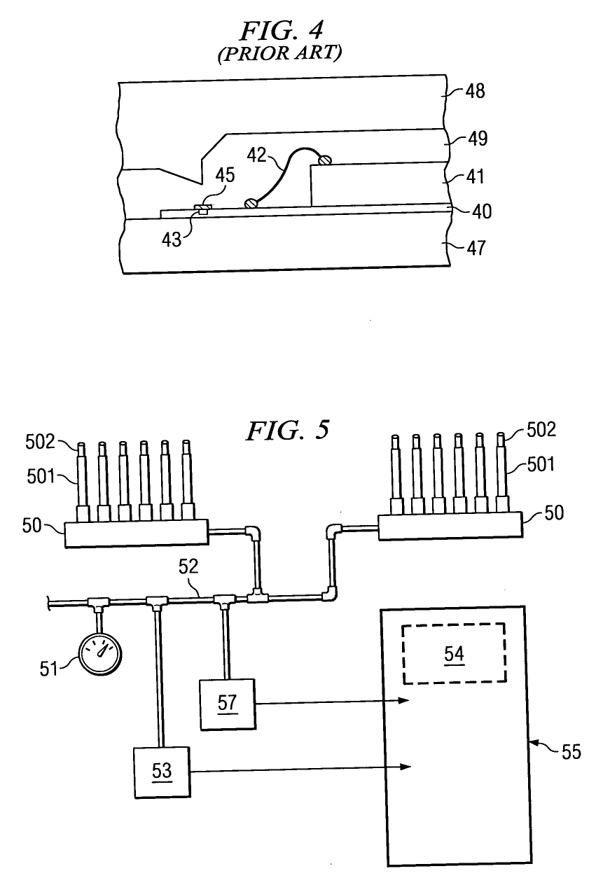

As shown in FIG. 5, an exemplary multiplunger mold press includes two plunger units 50 having a plurality of plungers 501 to force resin 502 into the mold cavities (not shown). The embodiment mold press includes two independent pressure measurement devices 51 and 57 on the main hydraulic line 52 supplying both plunger units. The first pressure measurement device, an analogue pressure gauge 51, may be read directly and the pressure measurement from this gauge 51 converted to digital format by a hydraulic converter board 53, which in turn transmits the data to the mold system controller unit 55. A second pressure measurement device 57 independently samples transfer pressure on the same hydraulic line 52 and feeds the data to the system controller unit 55. The second measurement device 57 is preferably a pressure transducer transmitting digital data directly to the controller unit 55.

Data from the two measurements may be read independently from the process monitor 54.

In the embodiment mold equipment, software embedded within the controller 55 is programmed to make online comparison of data from the converter 53 to that from the transducer 57. Tolerances of the measurement device are comprehended in the software calculation, and if there is a discrepancy between the readings which exceeds the tolerances, the controller unit halts the molding process before additional devices are introduced into the system.

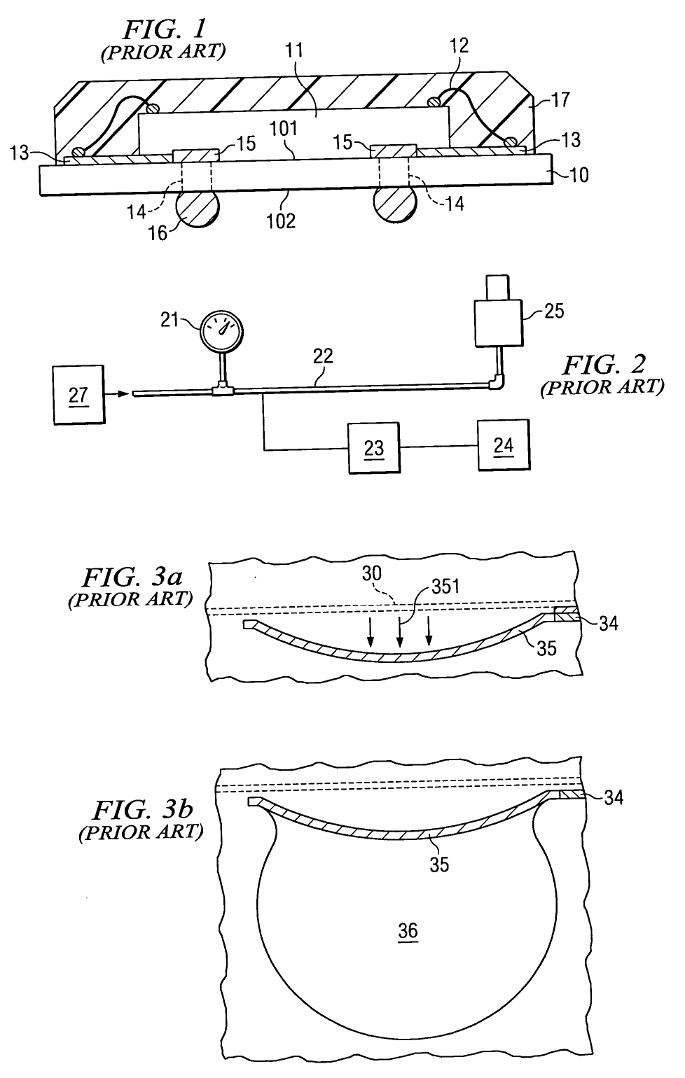

Multiplunger molds of known art, as shown in FIG. 2, are typically equipped with a single pressure measurement device, typically an analog gauge. In accordance with this invention, a multiplunger mold includes two or more pressure measurement devices for independent characterization of the mold process. Preferably, the additional pressure measurement device is a pressure transducer 57, and is added between the first device 51 and the system controller unit 55, as shown in FIG. 5. A suitable transducer may be obtained from Nagona Keike Co., Ltd., as Model KH15 having a range of 0 to 20 mega pascals, and is installed by mounting on the output port of a solenoid valve supplying hydraulics for the multiplunger unit.

Data from the pressure transducer 57 is transmitted directly to the controller 55 and monitor 54 for direct comparison to the data from pressure measurements of the gauge 51 and converter 53.

Further, the embodiment mold controller software program imports data from each of the measurement devices, compares the results between the devices, and takes into the calculation the tolerances of the measurement devices. If a discrepancy between the data is greater than an allowable set value, the mold equipment will be halted prior to introduction of additional semiconductor devices to be molded. This equipment having an inline monitor between pressure gauges avoids production of multiple faulty semiconductor devices as a result of inaccurate pressure control.

The embodiment mold press may be a traditional multiplunger mold modified to include more than one pressure measurement devices installed on the hydraulic line supplying transfer pressure, and software in the controller unit programmed to compare data between the measurements.

The exemplary mold press in FIG. 5 included two plunger units on the same hydraulic line, however, in a different press configuration, pressure to various plunger units may be on separate hydraulic lines, and in such case, it is preferable to have more than one pressure measurement device on each hydraulic line.

Inclusion of at least two independent pressure measurement devices on the hydraulic transfer pressure line of a mold press is applicable to all hydraulic molding equipment in order to provide a method for process control. Programming of software and addition of a pressure transducer are cost effective measures for inline process control of mold transfer pressure.

An improved method and equipment for controlling transfer pressure during the molding process prevents distortion of molded packages, or components of packages. A second, independent pressure measurement coupled into the hydraulic line allows an inline check of the first pressure measurement, and if there is a disparity, the process is shut down for corrective actions.

It will be recognized that the embodiment pressure measurement system is applicable to many hydraulic molding equipment configurations, and that the process is applicable and beneficial to many molded semiconductor devices. Modifications and variations will become apparent to those skilled in the art, and therefore, it is intended that the appended claims be interpreted as broadly as possible in view of prior art.

What is claimed is:

1. A process for inline measurement of hydraulic pressure during molding of semiconductor devices, including the steps of:
providing a mold equipment having at least two independent pressure measurement devices installed on the transfer pressure hydraulic line;
providing a mold equipment controller unit including a process monitor, and software programmed to receive data from each of said measurement devices; and
comparing data from each of said pressure measurement devices to data from the other devices.

2. The process of claim 1 wherein said data from said pressure measurement devices are independently input to said mold equipment controller unit, and output at the process monitor.

3. The process of claim 1 wherein said step of providing molding equipment comprises providing a hydraulic multiplunger mold system.

4. The process of claim 1 wherein said semiconductor device comprises a flex film interposer on a BGA type package.

5. The process of claim 1 wherein a first of said pressure measurement devices comprises an analog gauge with a digital conversion board, and said second measurement device comprises a pressure transducer.

6. The process of claim 1 wherein the second pressure measurement device is positioned on said transfer pressure hydraulic line between the first of said measurement devices and said mold controller unit.

7. The process of claim 1 wherein said semiconductor device is a thin leaded package.

8. The process of claim 1 further including molding said semiconductor device in said molding equipment by the following steps;
positioning a substrate having an attached semiconductor chip in the cavity of said mold equipment;
injecting a thermoset resin by hydraulic pressure to fill the mold cavity; and
measuring the transfer pressure by said independent pressure measurement devices.

9. A method of inline process control of mold transfer pressure, comprising the steps of:
providing a mold equipment having at least two independent pressure measurement devices installed on the transfer pressure hydraulic line;
providing a mold equipment controller unit with software for receiving and comparing data from said measurement devices;
comparing the pressure data from said pressure measurement devices; and
causing said molding equipment to be halted if the deviation between said measurements is greater than preset tolerance limits.

10. The method of claim 9 wherein said software program further compares said data from each measurement device to tolerance limits of the device.

11. A mold press equipment including more than one pressure measurement devices installed on a transfer pressure hydraulic line.

12. The mold press equipment of claim 11 having software programmed to compare the values between pressure measurement devices, and to compare the data to preset tolerance limits.

13. The mold press equipment of claim 11 wherein one of said measurement device comprises an analog gauge with a digital conversion board, and wherein a second pressure measurement device is a pressure transducer.

14. The pressure transducer of claim 13 wherein the pressure range is between 0 and 20 mega pascals.

15. The mold press equipment of claim 11 wherein the pressure data from each of said measurement devices is transmitted to a system controller and monitor.

16. The mold press equipment of claim 11 wherein said equipment is a hydraulic multiplunger mold press.

17. The mold press equipment of claim 11 wherein said hydraulic line is the main pressure line supplying transfer pressure to the molding process.

18. The mold equipment of claim 11 wherein more than one pressure measurement device is included on each hydraulic line supplying transfer pressure to the mold press.
